(19) United States
(12) Patent Application Publication
(10) Pub. No.: US 2013/0099433 A1
(43) Pub. Date: Apr. 25, 2013

(54) RECOIL SPRING ASSEMBLY

(71) Applicant: TIMOTHY D. WODRICH, REILES ACRES, ND (US)

(72) Inventor: TIMOTHY D. WODRICH, REILES ACRES, ND (US)

(21) Appl. No.: 13/276,872

(22) Filed: Oct. 19, 2011

(51) Int. Cl. B62D 55/30; F16F 1/06

(52) U.S. Cl. 267/71

(57) ABSTRACT

A recoil spring assembly includes a rod which has a flange at one end and a groove spaced apart from the flange. A first collar receives the rod and is mounted adjacent to the flange. A compressed spring engages the first collar. A second collar receives the rod and engages a second end of the spring. A pair of retainer clips is releasably received by the groove to retain the second collar to maintain compression of the spring.

### FIELD OF THE INVENTION

The present disclosure relates to a recoil spring assembly, such as for a track adjuster in a tracked vehicle.

### BACKGROUND OF THE INVENTION

Recoil spring assemblies are used in current track adjuster assemblies. In current recoil spring assemblies, the compression spring is held on a rod by a large threaded bushing which is screwed on to a threaded end of the rod. When such an assembly is new with little or no corrosion, the assembly can be disassembled and serviced without the use of a compression tool. In normal use, the assembly, including the threaded bushing and rod, can become corroded, thus making disassembly difficult. In this situation a compression tool is required for both disassembly and re-assembly.

### SUMMARY

According to an aspect of the present disclosure, a recoil spring assembly includes a rod which has a flange at one end and a groove spaced apart from the flange. A first hollow collar receives the rod and is mounted adjacent to the flange. A compressed spring has a first end which engages the first collar. A second collar receives the rod and engages a second end of the spring. A pair of retainer clips is releasably received by the groove to retain the second collar to maintain compression of the spring. The second collar includes a smaller diameter first bore and a larger diameter second bore, separated by a tapered bore which forms a frustoconical surface on an interior of the collar. Each retainer clip includes a cylindrical outer wall, and a tapered end wall which matingly engages the frustoconical inner surface.

This design eliminates the need for a threaded bushing and rod. This assembly is simple to manufacture, assembly and service. Other than a compression tool, no extra tools are required. The retaining clips are not affected by corrosion. The invention requires fewer components and they are manufactured with few process steps.

The advantage of the invention is that it utilizes existing service tooling in a service shop. It allows the adjuster recoil spring assembly to be removed from a track frame and serviced without special tooling. It is lower in manufacturing cost since it does not have machines features which become corroded and difficult to service over time.

### BRIEF DESCRIPTION OF THE DRAWINGS

FIG. 1 is a perspective exploded view of a recoil spring assembly embodying the invention;

FIG. 2 is a perspective view of the recoil spring assembly of FIG. 1;

FIG. 3 is a sectional view of a portion of the recoil spring assembly of FIG. 1;

FIG. 4 is a sectional view in the direction of arrows 4-4 of FIG. 3; and

FIG. 5 is a perspective view of the retainer clip of FIG. 1.

### DETAILED DESCRIPTION OF THE DRAWINGS

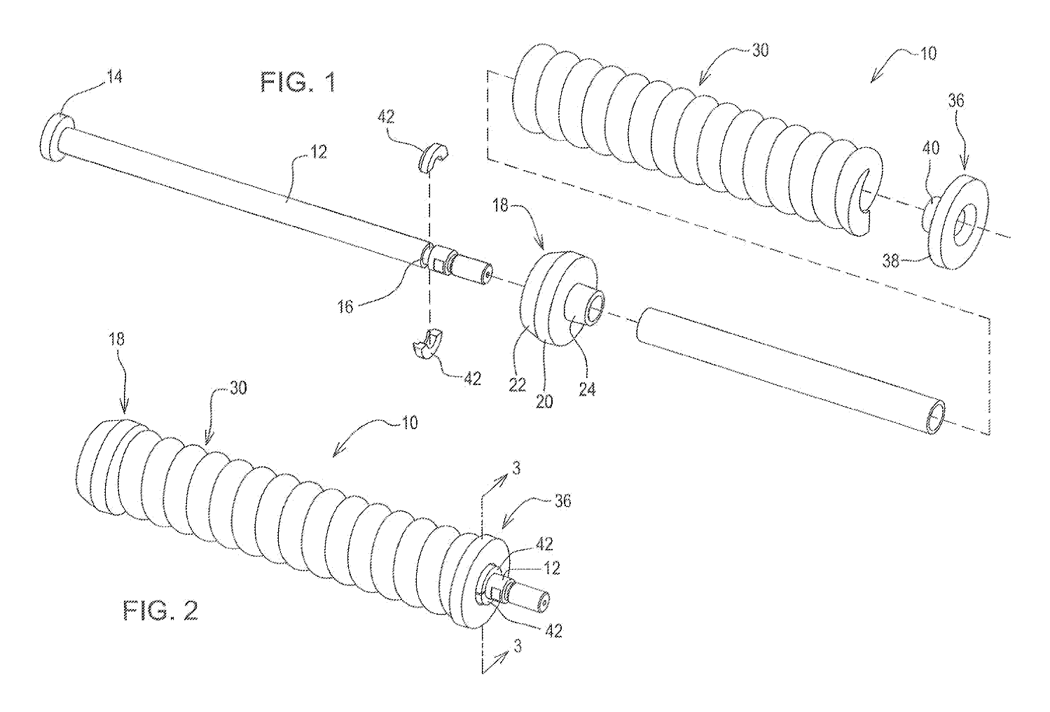

Referring to FIGS. 1 and 2, a recoil spring assembly 10 includes a cylindrical rod 12 which has a flange 14 at one end. An annular groove 16 is formed in the rod 12 and is spaced apart from the flange 14.

A first hollow collar 18 receives the rod 12 and is mounted adjacent to the flange 14. Collar 18 includes a cylindrical disk 20 which is between a smaller diameter sleeve portion 22 and end part 24. Sleeve portion 22 is received by a first end of compression spring 30. End part 24 engages the flange 14, and the first end of the spring 30 engages the disk 20 of the first collar 18. The spring 30 is a coil spring which receives the rod 12.

A second hollow collar 36 receives the rod 12, and has a disk 38 and a smaller diameter sleeve 40. The disk 38 engages a second end of the spring 30, and the sleeve 40 is received by the second end of the spring. The spring 30 is thereby mounted on the rod 12 and held between the first collar 18 and the second collar 36.

A pair of retainer clips 42 are releasably received by or mounted in the groove 16. The clips 42 retain the second collar 36 on the rod 12 and maintains compression of the spring 30. The retainer clips 42 and the second collar 36 cooperate to maintain compression of the spring 30.

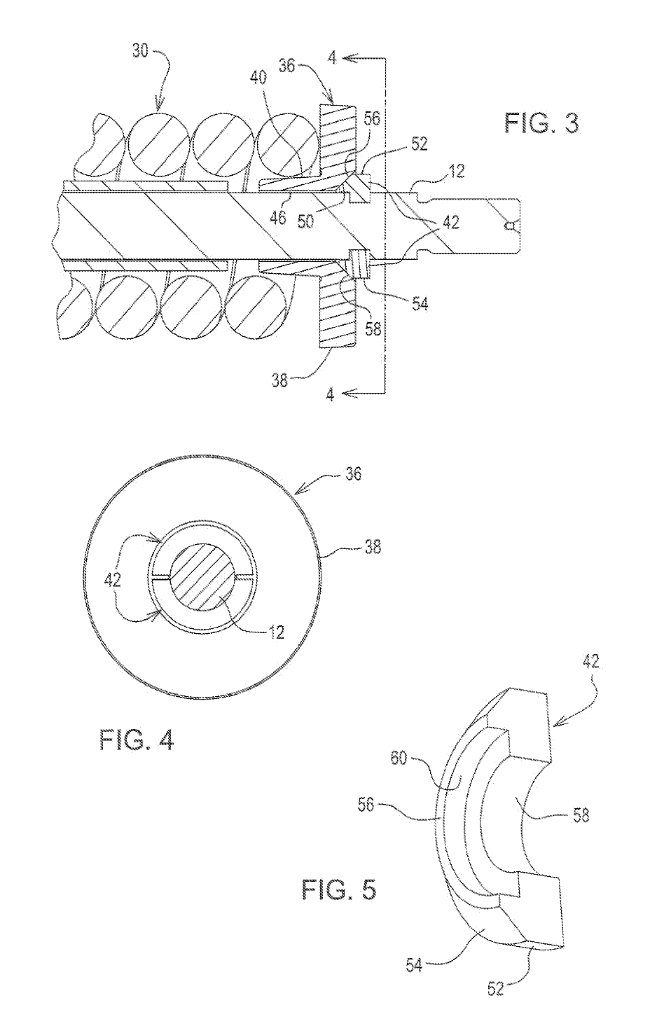

As best seen in FIG. 3, the second collar 36 includes a smaller diameter first bore 46 and a larger diameter second bore 48. Bores 46 and 48 are separated by a tapered bore 50 which forms a frustoconical surface on the interior of the collar 36.

As best seen in FIGS. 4 and 5, each retainer clip 42 has a semi-circular shape. Each retainer clip 42 includes a cylindrical outer wall 52, a tapered wall 54, and an annular axially facing end wall 56. Each retainer clip 42 includes a smaller diameter inwardly facing wall 58 and a larger diameter inwardly facing wall 60. Wall 58 is received by groove 16 and is adjacent a bottom surface of groove 16. Wall 60 engages outer surface of the rod 12.

To assemble this recoil spring assembly 10, the first collar 18 is slid over the rod 1 until it engages the flange 14. The spring 30 is then slid over the rod 12 and compressed against the collar 18 with a compression tool (not shown). When the spring 30 is compressed, the second collar 36 is slid onto the rod and then held in place with the two retaining clips 42, similar to how valves and springs are retained in an engine head. A compression tool is required to compress the assembly for service and assembly. If the recoil spring 30 requires servicing, the recoil spring assembly 10 is removed from the track frame (not shown). The assembly 10 is then compressed using the compression tool. Once compressed, the two clips 42 are removed and then the compression tool is released.

Each of the retaining clips 42 has a tapered surface which mates with a corresponding surface of the second collar 36. As the spring force pushes against the second collar 36 along the axis of the rod 12, the force is reacted or opposed by the retaining clips 42. As the force is transferred to the retaining clips through the tapered surface, the force is both absorbed by a wall of the groove 16 in the rod 12 and is opposed by the force acting normal to the axis of the rod 12. This provides two reactionary forces to counteract the axial force from the compressed spring 30.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

I claim:

1. A recoil spring assembly, comprising:
a rod having a flange at one end and a groove spaced apart from the flange;
a first hollow collar which receives the rod and is mounted adjacent to the flange;
a compressed spring which has a first end which engages the first collar;
a second collar which receives the rod and which engages a second end of the spring; and
a retainer clip releasably received by the groove, the clip retaining the second collar to maintain compression of the spring.

2. The recoil spring assembly of claim 1, wherein:
the second collar comprises a frustoconical inner surface; an
the retainer clip includes a tapered wall which matingly engages the frustoconical inner surface.

3. The recoil spring assembly of claim 1, wherein:
the second collar comprises a smaller diameter first bore and a larger diameter second bore, the first and second bores being separated by a tapered bore which forms a frustoconical surface on an interior of the collar; and
the retainer clip includes a cylindrical outer wall, and a tapered end wall which matingly engages the frustoconical inner surface.

4. A recoil spring assembly, comprising:
a rod having a flange at one end and a groove spaced apart from the flange;
a first hollow collar which receives the rod and is mounted adjacent to the flange;
a compressed spring which has a first end which engages the first collar;
a second collar which receives the rod and which engages a second end of the spring; and
a pair of retainer clips, each retainer clip being releasably received by the groove, the clips retaining the second collar to maintain compression of the spring.

5. The recoil spring assembly of claim 4, wherein:
the second collar comprises a frustoconical inner surface; an
each retainer clip includes a tapered wall which matingly engages the frustoconical inner surface.

6. The recoil spring assembly of claim 4, wherein:
the second collar comprises a smaller diameter first bore and a larger diameter second bore, the first and second bores being separated by a tapered bore which forms a frustoconical surface on an interior of the collar; and
each retainer clip includes a cylindrical outer wall, and a tapered end wall which matingly engages the frustoconical inner surface.

7. A recoil spring assembly, comprising:
a rod having a flange at one end and a groove spaced apart from the flange;
a first collar mounted on the rod adjacent to the flange;
a second collar mounted on the rod;
a spring mounted on the rod and held between the first collar and the second collar; and
a retainer clip releasably mounted in the groove, the clip and the second collar cooperating to maintain compression of the spring.
